(19) United States
(12) Patent Application Publication
(10) Pub. No.: US 2008/0316854 A1
(43) Pub. Date: Dec. 25, 2008

(54) Microfluid mixer

(75) Inventors: Shau-Chun Wang, Chiayi City (TW); Hsiao-Ping Chen, Taipei County (TW); Chia Yu Lee, Tainan County (TW); Hsueh-Chia Chang, Granger, IN (US)

Correspondence Address: BACON & THOMAS, PLLC, 625 SLATERS LANE, FOURTH FLOOR, ALEXANDRIA, VA, 22314-1176, US

(73) Assignee: NATIONAL CHUNG CHENG UNIVERSITY, Chia- Yi (TW)

(21) Appl. No.: 12/076,378

(22) Filed: Mar. 18, 2008

(30) Foreign Application Priority Data
Jun. 20, 2007 (TW) 096122150

(51) Int. Cl. B01F 11/02

(52) U.S. Cl. 366/127

(57) ABSTRACT

A microfluid mixer is provided. The non-linear electrokineticsis is applied to the design of the microfluid mixer. The microfluid mixer comprises a first and a second microfluidic elements, a mixing reservoir, and a micro channel unit, wherein the micro channel unit has at least two control channels for respectively connecting the first and the second microfluidic elements and the mixing reservoir. When two microfluids are mixed in the mixing reservoir, the electro-osmosis fluid field of the microfluids in the control channel of the mixing reservoir is changed by applying AC signal, such that powerful chaotic mixing effect is therefore produced by the two microfluids in the mixing reservoir.

### FIELD OF THE INVENTION

The present invention relates to a microfluid mixer, and more particularly to a microfluid mixer that adopts the non-linear electrokinetics as the design.

### BACKGROUND OF THE INVENTION

An issue of mixing two or more fluids in the shortest time under a micro dimension is considered extensively in the field of TAS (Total Analysis Systems), drug delivery, biomedical diagnosis as well as rapid drug detection and chemical detection in the past decade. However, none of the conventional methods of facilitating the mixing, such as the three dimensions of turbulent fluid and flow field, and flow field agitated by external forces, can be effectively applied to the micro dimension.

One factor of difficulty mixing fluids in a microfluid device is that the Reynolds number in the micro tube is very low under the normal operating condition such as a tube with 1 mm in width and with a flow speed of 1 mm/s. The fluid in the micro tube can only flow in a form of laminar flow. When there is no turbulent flow, the fluids mixing can only be done through molecular diffusion. Therefore, although the microfluid device only has a fluid unit with nano sizes therein, the mixing achieved by relying on pure diffusion will take a long time. For example, with respect to a bio-molecule with low diffusion coefficient, such as large protein having diffusion coefficient of D=5×10⁻⁶ cm²/s, the mixing time required between bio-molecules in a tube with a width l=1 mm is t=l²/D which is more than a half hour. Such the mixing time is usually longer than reaction time, and thus the entire reaction process is restricted by diffusion.

Therefore, in recent years, a variety of microfluid mixers have been developed to overcome the diffusion constraint in the device, wherein the microfluid mixers can be divided into passive mixers and active mixers.

Passive mixers mainly include some complex geometric structures added into the micro tube to increase the contact area between two fluids, such that the distance of diffusion to achieve the mixing effect. According to the above description, Jacobson et al., 1999; Schwesinger et al., 1996; Strook et al., 2002 utilized the concept of flow splitting to design branch tubes arranged in parallel so as to drive the fluid with electrical voltage. As a result, the flow splitting is generated by the fluid in the crossly arranged tubes, thereby increasing the contact area of the fluid. As shown in FIG. 1, a passive mixer 1 utilizes flow splitting to reduce the diffusion length L or a slope channel in the bottom of the tube to increase horizontal movement of the fluids 11, 12. However, the complex geometric structure of the passive mixer increases the flow field resistance. The manufacturing process also becomes more difficult and thus is hard to be implemented.

Additionally, when being utilized on electro-osmosis or electrophoresis biochips, these tubes have a very large potential drop at the corner and thus giant molecules, such as proteins, can be easily accumulated at the corner.

Active mixers mainly achieve the mixing effect by adding moving parts in the flow field or by using an external electrical field or pressures. FIG. 2 illustrates a schematic view of a mixer 2 used to achieve the mixing effect in “Instability of electrokinetic microchannel flows with conductivity gradients” disclosed by Oddy et al. in 2001. Firstly, a peristaltic pump 20 pumps microfluid A 231 and microfluid B 232 into a mixing reservoir 21. A high voltage amplifier 22 imposes an alternating voltage of 10³ V/cm and 20 Hz frequency at two sides of the mixing reservoir 21 such that the two microfluids, namely microfluid A and microfluid B, in the mixing reservoir 21 become unstable so as to speed up the mixing of the two fluids. Although a mixer of this type with instability of electrokinetic microchannel flows has a good mixing effect, it requires a very large potential drop (10³ V/cm). However, the large potential drop can easily cause protein molecules to be accumulated since it is unsuitable to be applied to the biochip to perform bio-analysis. In order to overcome the above problem, electrokinetic flow is commonly used in the conventional art as a driving force. However, the strength of vortex will be restricted by the slow speed of electro-osmosis and electrophoresis. In such system, the flow speed of electro-osmosis generated by a typical electrical field of 100 V/cm is still less than 1 mm/s. That is, the mixing strength is still quite weak.

Refer to FIG. 3a, which illustrates a mixer designed in accordance with “Electrokinetic micropump and micromixer design based on AC faradaic polarization” disclosed by Lastochkin et al., 2004. As shown in the figure, in the application of AC electrical field, asymmetric positive electrode 31 and negative electrode 32 are provided on a bottom wall 30 so as to generate an electro-osmotic flow to drive the microfluid (not shown) flow. “Asymmetric” refers to that the positive electrode 31 and the negative electrode 32 are provided on the same surface and ranked into a straight line. An electro-osmotic flow then is generated to drive the microfluidic flow. In FIG. 3a, the narrower curve represents the electrical field while the thicker solid line represents the flow field. In a half cycle duration, the left electrode is the positive electrode 31, and the right electrode is the negative electrode 32. In FIG. 3b, in the half cycle duration, the left electrode is the negative electrode 32, and the right electrode is the positive electrode 31.

However, it is unfortunate that this type of micropumps requires high frequency (>100K Hz) and high voltage to generate the microfluidic flow while the micropumps at low frequency may fail to precisely control the flow and thus such micropumps are less often used.

### SUMMARY OF THE PRESENT INVENTION

Therefore, one object of the present invention is to provide a microfluid mixer. When two microfluids are mixed in a mixing reservoir, a dielectric surface can form a dissipation layer through an induced polarity effect so as to generate a polarized electric potential by applying an AC signal with high frequency. When the dielectric surface is polarized by the electrical field, ions with the opposite charges in the electrolyte solution will migrate to the surface and form a field-induced electrical double layer. The field-induced electrical double layer is similar to a capacitive charging mechanism. The occurrence of capacitive charging allows the anode and cathode units to be provided on the outside of the mixing reservoir, thereby reducing the generation of bubbles and preventing the electrode units from directly contacting with a sample.

Another object of the present invention is to provide a system for analyzing a microfluidic mixing sample. The system of the present invention provides an imaging device for capturing at least one image signal of the mixing procedure of two microfluids. The present invention also utilizes digital image analysis software, such as Scion Image beta, built-in a personal computer of the system to analyze the images retrieved from the experiment so as to assess the quantitative data of the mixing efficiency of the two microfluids.

In accordance with the above objects, the microfluid mixer includes a panel, a power supply and an electrode unit, wherein the panel is provided with a first and a second fluidic element, a chamber and a micro-channel unit, wherein the chamber is provided between the first and the second fluidic elements. The micro channel unit has at least two control channels connected with the first and second fluidic elements and the chamber respectively. The power supply provides a variety of voltage modes so as to drive the above-mentioned fluidic elements. The electrode unit has two electrodes provided at two sides of the control channels of the micro channel unit, wherein the power supply changes the electro-osmosis flow field of the two microfluids in the above control channels is changed when the power supply supplies voltages to the two electrodes such that the two microfluids within the mixing reservoir generate an intensive chaotic mixing effect.

### BRIEF DESCRIPTION OF THE DRAWINGS

The above and other objects of the present invention may be more apparent to those skilled in the art through the detailed description and the accompanying drawings, wherein:

FIG. 1 illustrates the convention mixer with crossly arranged tubes;

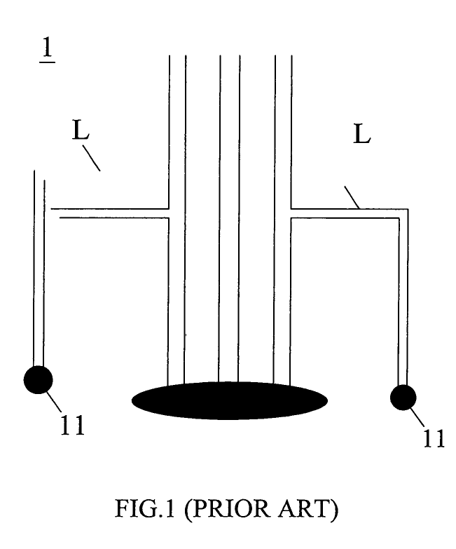

FIG. 2 illustrates another conventional mixer with an instabile electrokinetic flow;

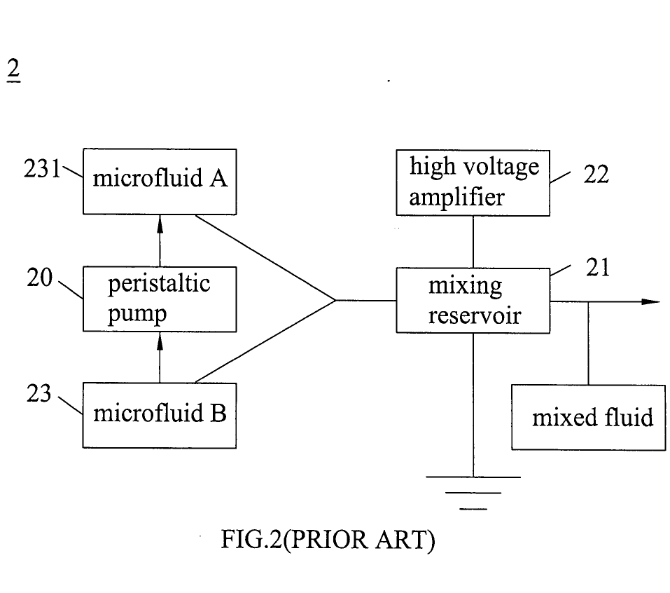

FIG. 3a illustrates asymmetric electrodes generating an AC electro-osmotic flow;

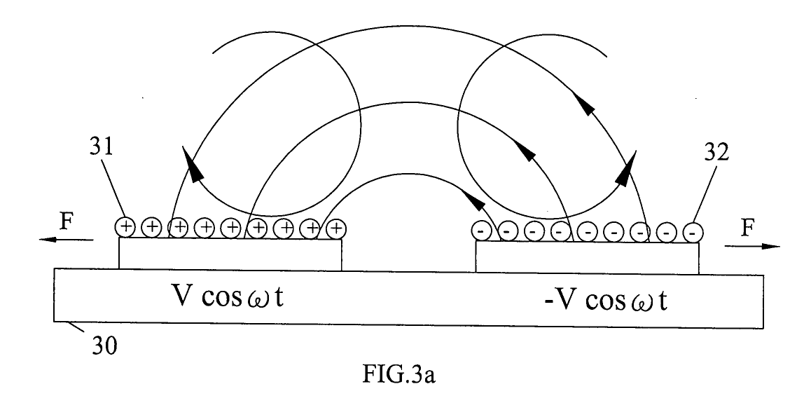

FIG. 3b illustrates asymmetric electrodes generating another AC electro-osmotic flow;

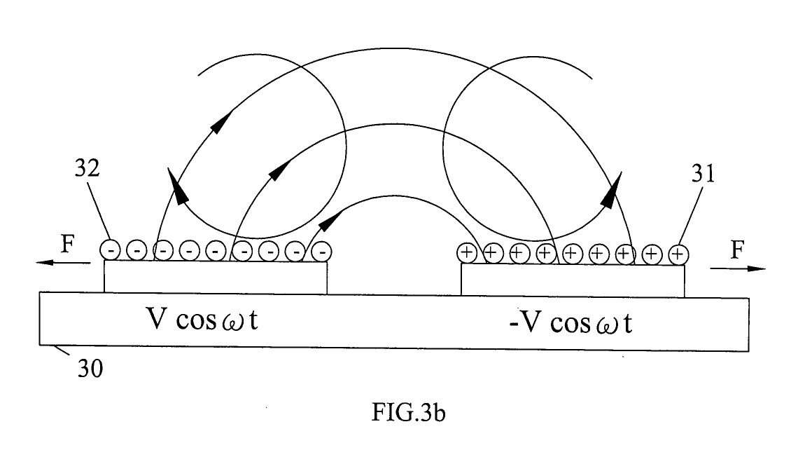

FIG. 4 illustrates a schematic view of ion distribution of an electrical double layer and an electrical potential;

FIG. 5 illustrates a schematic view of a electro-osmotic flow field speed;

FIG. 6 illustrates a schematic view of a microfluid mixer designed in accordance with a non-linear electrokinetic flow mechanism;

FIG. 7 illustrates a schematic view of experimenting the microfluid mixer of FIG. 6;

FIG. 8 illustrates a schematic view of a measure configuration of a system for analyzing a microfluid mixing sample; and

FIG. 9 illustrates a flow chart of a method for analyzing a microfluid mixing sample.

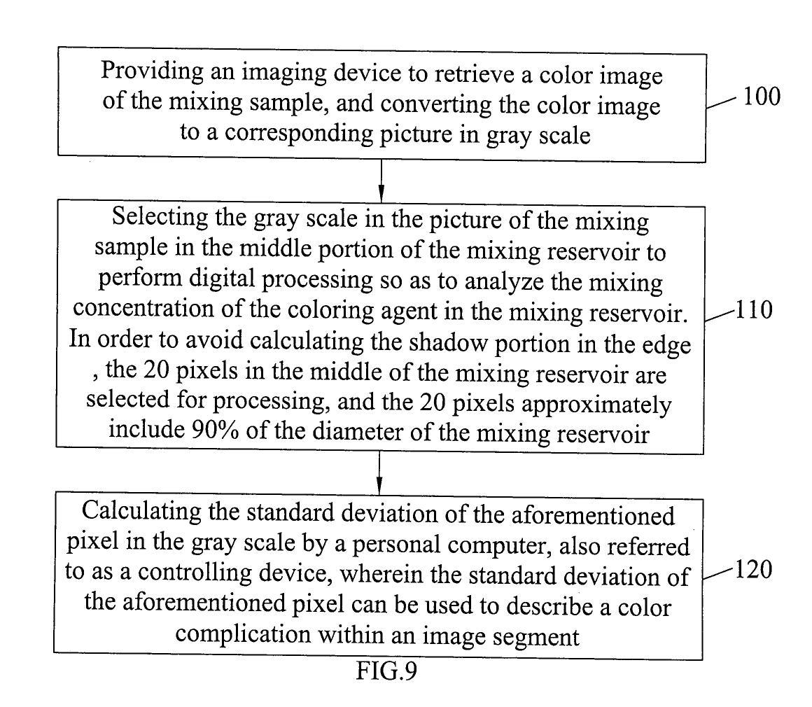

### DETAILED DESCRIPTION OF THE EMBODIMENTS

The preferred embodiment is described in detail below. However, it should be noted that the present invention provides a variety of concepts that can be utilized in the present invention. These concepts can be applied to a variety of specific embodiments. Specific embodiments discussed herein are for illustrative purpose only and do not mean to limit the scope of the present invention.

In general, a majority of the solid-liquid interface will contain electrical charges. These electrical charges can attract the counter-ions in the electrically neutral liquid such that the concentration of the liquid counter-ions near the solid surface will be higher than that of the co-ions, thereby creating an electrical double layer, (EDL), which is also referred to as the Debye layer. For silica material, when the Si—OH functional group on the wall of the channel dissolves in the liquid, it will generate negative charges, SiO⁻, on the wall, and thus attract the ions with positive charges to accumulate around the wall in the electrolyte.

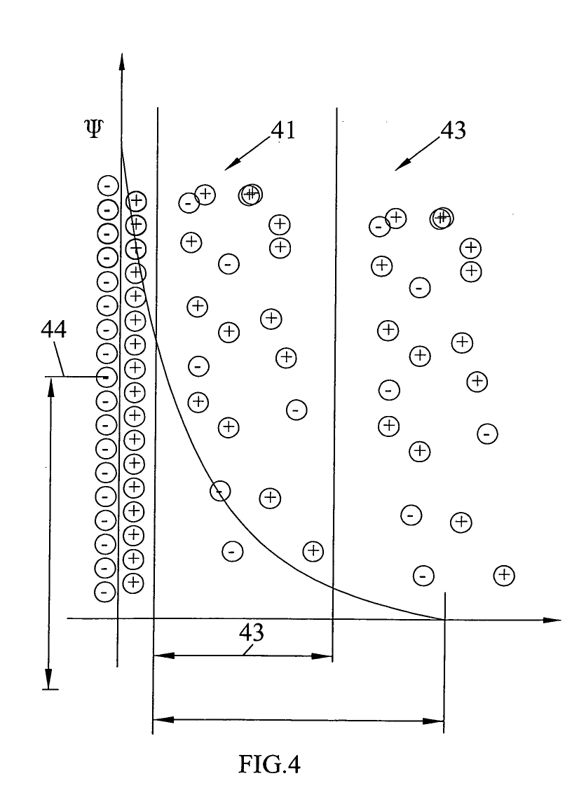

FIG. 4 illustrates a schematic view of the ion distribution of the electrical double layer and the potential. The electrical double layer can mainly be divided into two groups: a stem layer 41 having ions with positive charges immovably adsorbed to the wall of the channel and a diffuse layer 42 having movable diffusive ions being distant from the wall, wherein the density of the electrical charges rapidly decreases as the distance of the diameter increases. Deybe length refers to a characteristic thickness 43 of the electrical double layer. The potential is the maximum when it is on the wall, and it is decreased rapidly as it passes through the stem layer. The potential at the boundary between the stem layer 41 and the diffuse layer 42 is called Zeta potential 44 [symbol] .

When an electrical field is applied on the liquid surface in a tangent direction, the net electrical charge on the diffuse layer within the electrical double layer is influenced by the Maxwell stress. Since the outside of the electrical double layer is electrically neutral, the Maxwell stress is zero. The Maxwell stress in the electrical double layer is in proportional to the strength of the electrical field in the tangent direction. When the Maxwell stress gets balanced out with the viscous force, a Smolouchowski slip, also referred to as the electro-osmotic flow speed, is generated, and can be defined as below:

V eo=μeoE el

μeo=ε [symbol] /η

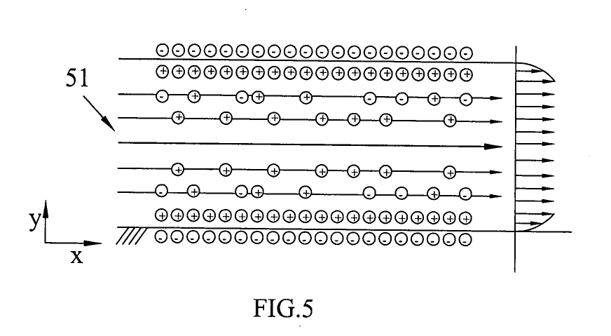

Therein, μeo is the phoresis of the solution itself; Eel is the strength of the electrical field applied; ε is the dielectric constant; [symbol] is the zeta potential; and η is the viscosity of the solution. As shown in FIG. 5, the electro-osmotic flow movement is from a high voltage field 51 (the applied electrical field, Eel) to a low voltage field in constant speed. Changes in the electro-osmotic flow will not only change the strength of the electrical field, but also change the pH value of the buffer solution. Alternatively, organic solvents or surfactants, etc. can also change the amount of electro-osmotic flow.

According to the above description, the present invention provides a microfluid mixer, described in an embodiment of changing the electrokinetic mobility of the mixing ions through an external electrical field. It should be noted that some items, such as fluid, microfluid, and chamber, mixing reservoir, and mixing device, mixer as well as micro channel, micro tube, and electrode, microelectrode are used interchangeably in the embodiments.

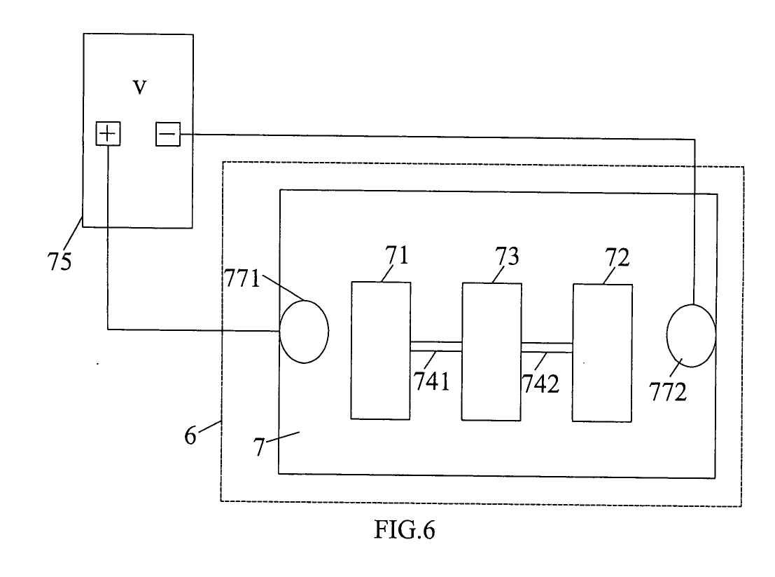

FIG. 6 illustrates a schematic view of the microfluid mixer in accordance with the present invention. The microfluid mixer 6 includes a panel 7, a chamber 73, a micro channel unit with a first control channel 741 and a second control channel 742, a power supply 75 and an electrode unit with a cathodeanode 771 and an anodecathode 772. The panel 7 is provided with a first fluidic element 71 and a second fluidic element 72. The chamber 73 is provided between the first fluidic element 71 and the second fluidic element 72. The first control channel 741 is used to connect the first fluidic element 71 and the chamber 73, while the second control channel 742 is used to connect the second fluidic element 72 and the chamber 73. The power supply 75 can provide different voltage modes of DC/AC to drive the fluidic element. A cathode 771 and an anode 772 are around the first fluidic element 71 and the second fluidic element 72, respectively. The electro-osmosis flow field of the above microfluids within the control channel is changed when the power supply 75 provides voltage to the two electrodes. The above-mentioned electrodes can be made of platinum, copper, titanium, chromium, aluminum, or other conductive materials. The present invention uses platinum as an exemplary material. The following is a description on the experimental data and experimental drawings of the present invention.

Biochips are often used for testing. In order to conveniently observe the status of the fluidic flow in the micro channel, transparent polymer materials are selected for convenient observation. The manufacturing process used in the embodiment is similar to the conventional process of manufacturing molds.

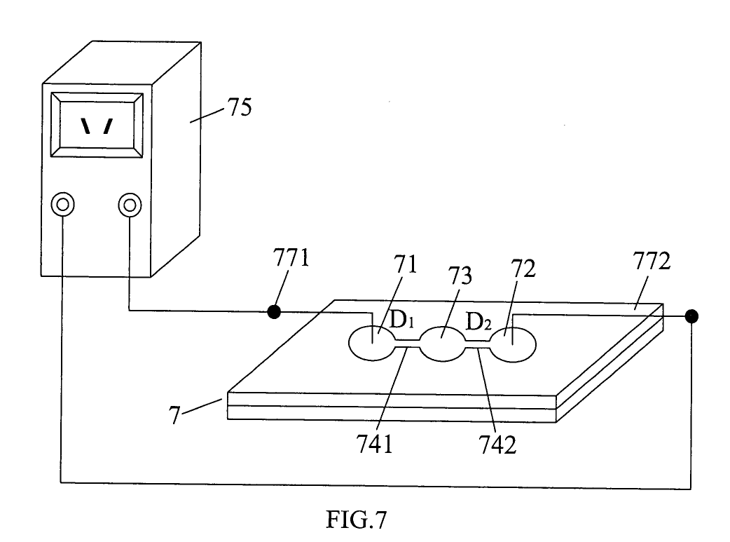

FIG. 7 illustrates a schematic view of experimenting a microfluid mixer in accordance with FIG. 6. Firstly, on a thermoplastic panel 7, which is usually made of a dielectric material, is a co-polyester plastic sheet with a dimension of 20 mm×40 mm×2 mm according to the present invention, and three circular grooves with the same diameter (3 mm) are drilled by the mechanical way. The three circular grooves are taken as the first fluidic element 71, the second fluidic element 72 and the mixing reservoir 73, respectively, and are connected with the mixing reservoir 73 through a straight-shaped first control channel 741 and a second control channel 742 having a diameter of 1×1 mm and a length of 12 mm. The distance length D1 between the first fluidic element 71 and the mixing reservoir 73 and the distance length D2 between the second fluidic element 72 and the mixing reservoir 73 have a ratio of D1:D2 ranging from 1:1 to 1:10. In other words, the ratio of distance length of D2:D1 ranges from 1:1 to 1:10 (In the embodiment, the ratio D1:D2 is set as 1:1). The diameter of the two fluidic elements is one to three times greater than the diameters of the two control channels as can be obtained from the diameter data of the two fluidic elements and the two control channels.

In order to reduce the number of bubbles generated in the experiment, the two electrodes 771, 772 are provided in the first fluidic element 71 and the second fluidic element 72 with the same distance, respectively, and are connected to the positive electrode and the negative electrode of the power supply 75, respectively.

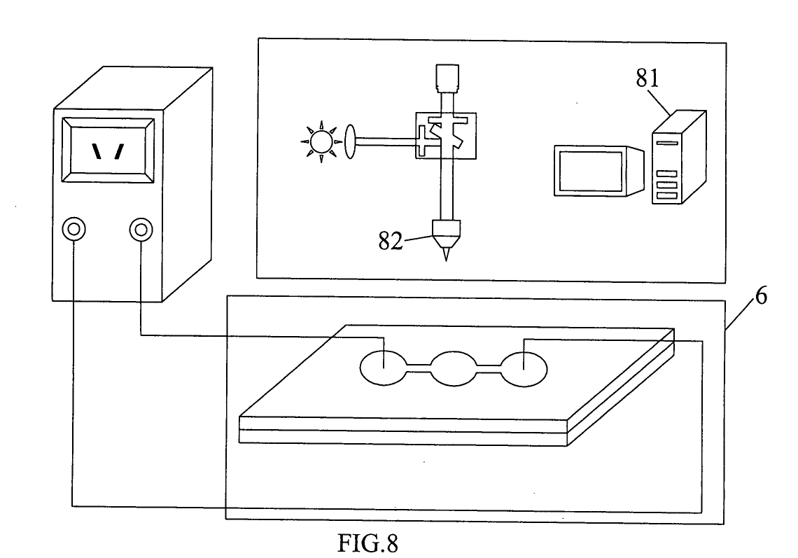

After the two microfluids are mixed in the mixing reservoir, the mixing effect of the present experiment can be analyzed. The present invention also provides a system for analyzing a microfluidic mixing sample. FIG. 8 illustrates a schematic view of the system for analyzing the microfluidic mixing sample in accordance with the present experiment, wherein the system 80 includes a controlling device 81 and an imaging device 82. The imaging device 82 is electrically connected to the controlling device 81. The controlling device 81 may be a personal computer, and the imaging device 82 may be one of a video camera or a camera for capturing at least one video signal of the mixing procedure of the two microfluids. Digital image analyzing software, such as Scion Image beta, built in a personal computer can be used to analyze the video image retrieved by the present experiment.

The following describes the working conditions for preparing the experiment equipment:

1. Selecting a coloring agent: in addition to the design of the microfluid mixer itself, the assessment of the mixing effect is also very important. The conventional assessing method mainly includes observing the color changes of the coloring agent or acid-base indicator in the mixing reservoir so as to perform quantitative analyses. The main analyzing method includes calorimetric analysis, fluorometric analysis and acid-base indicator. The present invention utilizes the calorimetric analysis which is to color the two microfluids with different colors, so that when the microfluids are mixed, the color change of the two microfluids is used to assess the mixing effect. The coloring agents used in the present experiment are blue and red food-colors. The diffusion coefficient of the food-colors is one order less than that of a small molecule in water, namely less than 1000 Dalton. Additionally, methylene blue and Rhodamine-6G are utilized to color Glycerin to clearly observe the microfluidic flow. In consideration of the coloring agent, the charge property thereof needs to be taken into account. Coloring agent is selected such that it will not pass through the incoming ion to block the important channels for ions. When the positive ion is used in exchange with particle size, a coloring agent with negative charges, such as Rhodamine-6G, is selected. When the negative ion is used in exchange with particle size, a coloring agent with positive charges, such as methylene blue, is used. The two coloring agents are mixed in the glycerin agent, and the mixing effect of the non-linear electrokinetic mixer is quantified by the mixing result with the color glycerin agent;

2. Setting the range of the different voltage mode (DC/AC) of the power supply to output at 10-1000 V_{rms/cm};

3. Injecting the first fluidic element 71 and the second fluidic element 72 as well as the chamber 73 with deionized water; and

4. Using a waveform generator to provide sinusoidal waveforms, triangular waveforms, rectangular waveforms with a variety of frequencies and phases or signals with other similar functions so as to provide an alternating signal for the aforementioned electrodes to generate dielectrophoresis.

Before performing the experiment, an ion is placed in the middle of the mixing reservoir. After two drops of coloring agent with different colors are dropped in the middle of the mixing reservoir, the alternating electrical field of the power supply or the waveform generator is turned on to generate an AC signal with amplitude of ±100 Vᵣₘₛ/cm. The overall process is captured by the video camera, and the digital image analyzing software is used to analyze the image retrieved from the present experiment so as to access the mixing efficiency.

After the AC electrical field of a sine wave (94 Vᵣₘₛ/cm, 100 kHz) is generated in the mixing reservoir, the mixing effect is observed at the 0^{th} second, the 10^{th} second, the 20^{th} second, and the 30^{th} second, and it is certified that the two separate glycerin coloring agents are uniformly mixed within 30 seconds. At the same time, an electro migration effect with net electro-osmosis and ion may not be generated under the AC electrical field and the coloring agent will not be too far away from the mixing reservoir. As a result, sample can be less diluted to reduce the bubbles and pollutants released by the electrode reaction to the minimum.

According to the above mixing experiment in the AC electrical field, it can be found that the dielectric surface of ion can also form a dissipation layer on the surface thereof by the induced polarization to generate a polarized potential. When the dielectric surface is polarized by the electrical field, the ions with the opposite charges in the electrolyte will migrate to the surface to form a field-induced electrical double layer. Since the electrical double layer acts like a capacitor capable of containing charges, it can also be referred to as a capacitive charging mechanism. The advantage of generating AC capacitive charging on the dielectric surface is that the electrode can be placed in another solution reservoir. When the frequency is applied enough high, the bubbles generated on the surface of the electrodes can be reduced.

The best mixing effect requires the ions to migrate itself along with the vortex generated by polarization to co-exist. However, the speed of electrical migration generated by ions is faster than the speed of electrical-osmosis of the ions, and thus the low frequency will cause the dye to overflow the mixing reservoir. Therefore, the best AC electrical field frequency is between 1 kHz and 1 MHz; however, the frequency value varies depending on the size of the ion and the size of the mixing reservoir.

In order to obtain the best fluorometric identification effect of the two microfluids, the microfluid mixer of the present invention is required to be used in combination with the system for analyzing mixing sample for implementation. Additionally, when using the system for analyzing the mixing sample, the present invention provides a method for analyzing the microfluidic mixing sample. FIG. 10 illustrates a flow chart of the method for analyzing the two microfluids. The analyzing method includes:

Step 100: providing an imaging device to retrieve a color image of the mixing sample, and converting the color image to a corresponding picture in gray scale;

Step 110: Selecting the gray scale in the picture of the mixing sample in the middle portion of the mixing reservoir to perform digital processing so as to analyze the mixing concentration of the coloring agent in the mixing reservoir. In order to avoid calculating the shadow portion in the edge, the 20 pixels in the middle of the mixing reservoir are selected for processing, and the 20 pixels approximately include 90% of the diameter of the mixing reservoir; and

Step 120: calculating the standard deviation of the aforementioned pixel in the gray scale by a personal computer, also referred to as a controlling device, wherein the standard deviation of the aforementioned pixel can be used to describe a color complication within an image segment.

Based on the technical content of the present invention, it can be known that the designed microfluid mixer can allow the dielectric surface to form a dissipation layer on the surface thereof through the induced polarization while applying an AC signal in the mixing reservoir with 10 μL so as to form a polarized potential. When the dielectric surface is polarized by the electrical field, the ions with the opposite electrical charge in the electrolyte are migrated to the surface to form a field-induced electrical double layer. The field-induced electrical double layer works as a capacitive charging mechanism. The occurrence of the capacitive charging allows the anode and cathode of the electrode unit to be provided on the outside of the mixing reservoir so as to reduce the generation of bubbles and prevent the electrode unit from directly contacting the sample.

Accordingly, under the integration of the system for analyzing a microfluidic mixing sample and the microfluid mixer, the image signal generated by mixing the microfluids and the quantitative data of the mixing efficiency can be observed and assessed at the same time.

Although the present invention is described with the preferred embodiment above, it does not mean to limit the present invention. Those skilled in the art should know that modification and changes can be made without leaving the spirit and scope of the present invention. The scope of the present invention is set forth in the above claims.

What is claimed is:

1. A microfluid mixer, comprising:
a panel, wherein said panel is provided with:
a first and a second microfluidic elements;
a chamber located between said first and second microfluidic elements;
a micro channel unit having at least two control channels connected to said first and said second microfluidic elements and said chamber, respectively;
a power supply for providing different voltage modes to drive said microfluidic elements; and
an electrode unit having two electrodes located at two sides of said control channels of said micro channel unit, whereby said electrode unit changes an electro-osmosis fluid field of said microfluid in said control channels is changed when said power supply supplies voltages to said electrodes.

2. The microfluid mixer of claim 1, wherein said panel is made of a dielectric material.

3. The microfluid mixer of claim 1, wherein said electrode unit is made of any one of conductive materials consisting of platinum, copper, titanium, chromium, and aluminum.

4. The microfluid mixer of claim 1, further comprising a waveform generator for providing sinusoidal waveforms, triangular waveforms, rectangular waveforms with a variety of frequencies and phases or signals or signals with other similar functions.

5. The microfluid mixer of claim 1, wherein said control channel is in a straight form.

6. The microfluid mixer of claim 1, wherein a range of a distance ratio for a distance between one of said two control channels connecting said first microfluidic element and said chamber and a distance between another of said two control channels connecting said second microfluidic element and said chamber is from 1:1 to 1:10.

7. The microfluid mixer of claim 1, wherein a diameter of said microfluidic elements is about one to three times greater than a diameter of each said control channels.
